(19) United States
(12) Patent Application Publication
(10) Pub. No.: US 2021/0354958 A1
(43) Pub. Date: Nov. 18, 2021

(54) ELEVATOR SYSTEM VENTILATION

(71) Applicant: Man-D-Tec, Inc., Scottsdale, AZ (US)

(72) Inventors: Dalton John Mandy, Scottsdale, AZ (US); Terry Roy Mandy, Paradise Valley, AZ (US); Jose Jesus Sandoval, Tecoman (MX)

(21) Appl. No.: 17/320,339

(22) Filed: May 14, 2021

Related U.S. Application Data
(60) Provisional application No. 63/024,927, filed on May 14, 2020.
(60) Provisional application No. 63/025,946, filed on May 15, 2020.
(60) Provisional application No. 63/026,683, filed on May 18, 2020.
(60) Provisional application No. 63/028,119, filed on May 21, 2020.
(60) Provisional application No. 63/038,509, filed on Jun. 12, 2020.

(51) Int. Cl. B66B 11/02; F24F 8/22; F24F 1/0073; F24F 8/108; F24F 9/00; F24F 1/0022; F24F 11/61

(52) U.S. Cl. CPC B66B 11/024; F24F 8/22; F24F 1/0073; F24F 8/26; F24F 9/00; F24F 1/0022; F24F 11/61; F24F 8/108

(57) ABSTRACT

An elevator ventilation system comprising an ultraviolet source that illuminates elevator system air blown through an illumination chamber, and an air filter that filters the air as it flows through the chamber. The ultraviolet source is blocked from view from outside the illumination chamber. An air curtain emitter may expel a curtain of air across the elevator doorway, limiting air communication between an elevator interior and the elevator landing when elevator doors are open. An air outlet may be shaped to receive an elevator light fixture and to expel air into the elevator interior via an aperture adjacent the light fixture. An air curtain emitter may comprise an air outlet slot shaped to expel a curtain of air separating an interior of the elevator car into at least two air compartments defined by the “barrier” of the air curtain.

### FIELD

This application relates generally to ventilation of an elevator system.

### DESCRIPTION OF RELATED ART INCLUDING INFORMATION DISCLOSED UNDER 37 CFR 1.97 AND 1.98

It is known for elevators to be equipped with a ventilating fan that draws elevator system air from an elevator shaft or hoistway of the elevator system into a cab or passenger compartment of the elevator. The elevator system air may be drawn in from the elevator shaft through an inlet vent in a sidewall near a floor of the elevator. The air is then expelled back into the elevator shaft through an outlet vent in a ceiling or top panel of the elevator. Shaft air is thus circulated through and between the elevator cab and the elevator shaft. Such devices may be adequate for circulation air through an elevator cab, but they do little to mitigate the threat of infection of elevator passengers if one or more elevator passengers are carrying a disease caused by a pathogen that can survive and remain infectious when carried in an air mass.

Air filters and UV lighting are known means of removing or neutralizing airborne pathogens such as viruses and bacteria, however, they cannot readily be incorporated into elevator ventilation assemblies without first overcoming several engineering challenges.

### SUMMARY

An elevator ventilation system is provided, which comprises an illumination chamber positioned in fluid communication with elevator system air, an ultraviolet source positioned to illuminate elevator system air flowing through the illumination chamber, an air filter positioned to filter elevator system air flowing through the illumination chamber, and a blower disposed in fluid communication with the illumination chamber. The blower is configured to move elevator system air through the illumination chamber and through the air filter, and the ultraviolet source is blocked from view from positions outside the illumination chamber.

Also provided is an elevator doorway ventilation system that comprises a blower connected in fluid communication with an air curtain emitter. The air curtain emitter is positioned adjacent an elevator doorway, and the air curtain emitter is shaped and aimed to expel a curtain of air, received from the blower, across the elevator doorway, limiting air communication between an elevator interior and the elevator landing when an elevator car arrives at an elevator landing and elevator doors open.

Also provided is an elevator light ventilation system comprising a blower connected in fluid communication with an air outlet. The air outlet is shaped to receive an elevator light fixture and to expel air received from the blower into the elevator interior via an aperture adjacent the light fixture.

Also provided is an elevator ventilation system comprising a blower supported on an elevator car and an air curtain emitter supported on the elevator car and connected in fluid communication with the blower. The air curtain emitter comprises an air outlet slot shaped to expel a curtain of air. The air curtain emitter is further shaped and aimed to separate an interior of the elevator car into at least two air compartments defined by the “barrier” of the air curtain.

### DRAWING DESCRIPTIONS

FIG. 1 is an orthogonal view of a germicidal assembly of an elevator ventilation system;

FIG. 2 is a front view of the assembly of FIG. 1 with a front panel removed;

FIG. 3 is a left side view of the assembly of FIG. 1 with an air filter module moved upwards to reveal the assembly's interior;

FIG. 4 is an exploded orthogonal view of the air filter module of the system of FIG. 1;

FIG. 5 is a magnified perspective view of a blower of the assembly of FIG. 1 spaced above an adapter plate configured to mate the assembly to a pre-existing opening in an elevator canopy;

FIG. 6 is an orthogonal view of the adapter plate of FIG. 5;

FIG. 7 is an exploded orthogonal view of an elevator ventilation system comprising an alternate single-filter-module embodiment of the germicidal assembly of FIG. 1;

FIG. 8 is a front view of the assembly of FIG. 7 with the filter module removed;

FIG. 9 is a bottom view of the assembly of FIG. 7;

FIG. 10 is a right-side view of the assembly of FIG. 7;

FIG. 11 is a front view of the assembly of FIG. 7 connected to an exhaust plenum;

FIG. 12 is a right-side perspective view of the assembly of FIG. 7 mounted on an elevator canopy and connected to light fixture air outlets carried by an elevator drop ceiling panel;

FIG. 13 is an exploded view of one of the light fixture outlets of FIG. 12;

FIG. 14 is a right-side perspective view of the germicidal assembly of FIG. 7 mounted on an elevator canopy and connected to a pair of air curtain emitters;

FIG. 15 is a perspective view of an elevator car carrying an air curtain emitter aimed down from a position over a door of the elevator car;

FIG. 16 is a perspective view of an air curtain emitters carried by an elevator landing on either side of an elevator/elevator landing doorway;

FIG. 17 is a perspective view of an elevator ventilation system configured to move air through an elevator car from top to bottom;

FIG. 18 is a perspective view of the elevator ventilation system of FIG. 17 configured to move air through the elevator car from bottom to top;

FIG. 19 is a perspective view of an elevator car configured to carry a low-profile embodiment of a germicidal assembly of an elevator ventilation system;

FIGS. 20A through 20F show schematic views of further alternate elevator ventilation circulation configurations;

FIG. 21 shows a front perspective view of a compact embodiment of a germicidal assembly of an elevator ventilation system;

FIG. 22 shows a front view of the assembly of FIG. 21;

FIG. 23 shows a front view of the assembly of FIG. 21 with an access door open;

FIG. 24 shows a front perspective view of a low-profile embodiment of a germicidal assembly of an elevator ventilations system with an access door open and filters partially removed;

FIG. 25 shows a front view of the assembly of FIG. 24;

FIG. 26 shows a front view of the assembly of FIG. 24 with an access door open and filters removed;

FIG. 27 shows a front view of the assembly of FIG. 24 with an access door open and a UV source shield removed;

FIG. 28 shows a perspective view of an air sensor and occupation sensor carried in the interior of an elevator car;

FIG. 29 shows a lower perspective view of an elevator ventilation system that has split an elevator car into air compartments separated by air curtains; and

FIG. 30 shows the elevator ventilation system of FIG. 29, as well as markings on the floor of the elevator car that indicate to elevator passengers the locations of the separated air compartments.

### DETAILED DESCRIPTION

An elevator ventilation system is generally shown at 10 in the Figures. The elevator ventilation system 10 comprises an illumination chamber 16 positioned in fluid communication with elevator system air, an ultraviolet (UV) source 18 positioned to illuminate elevator system air flowing through the illumination chamber 16, an air filter 20 positioned to filter elevator system air flowing through the illumination chamber 16, and a blower 22 disposed in fluid communication with the illumination chamber 16. The blower 22 is configured to move elevator system air through the illumination chamber 16 and through the air filter 20, and the UV source 18 is blocked from view from positions outside the illumination chamber 16.

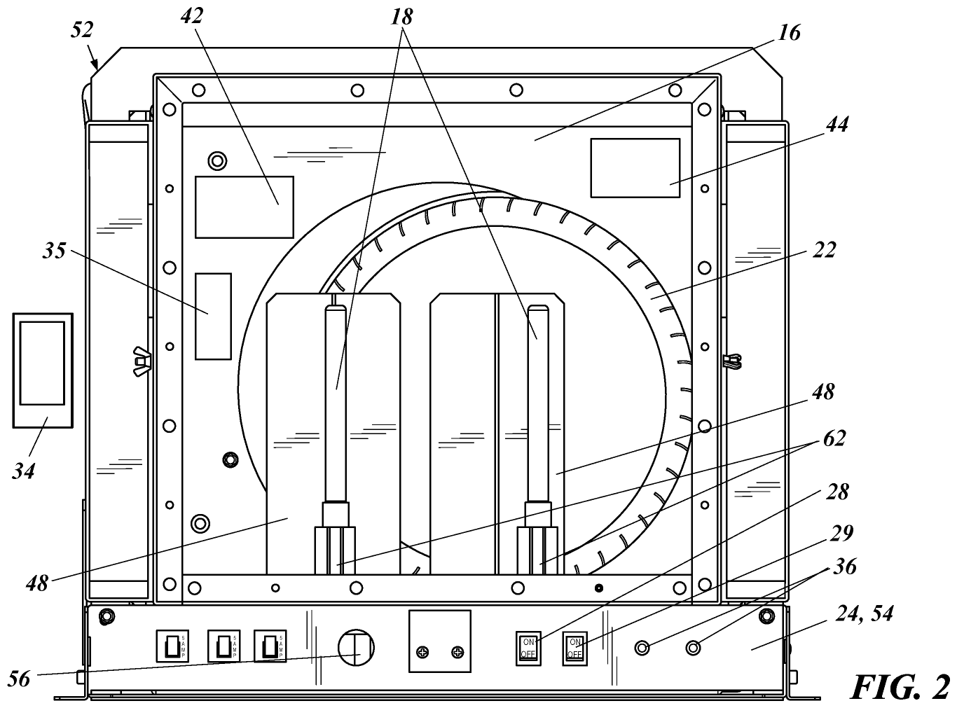

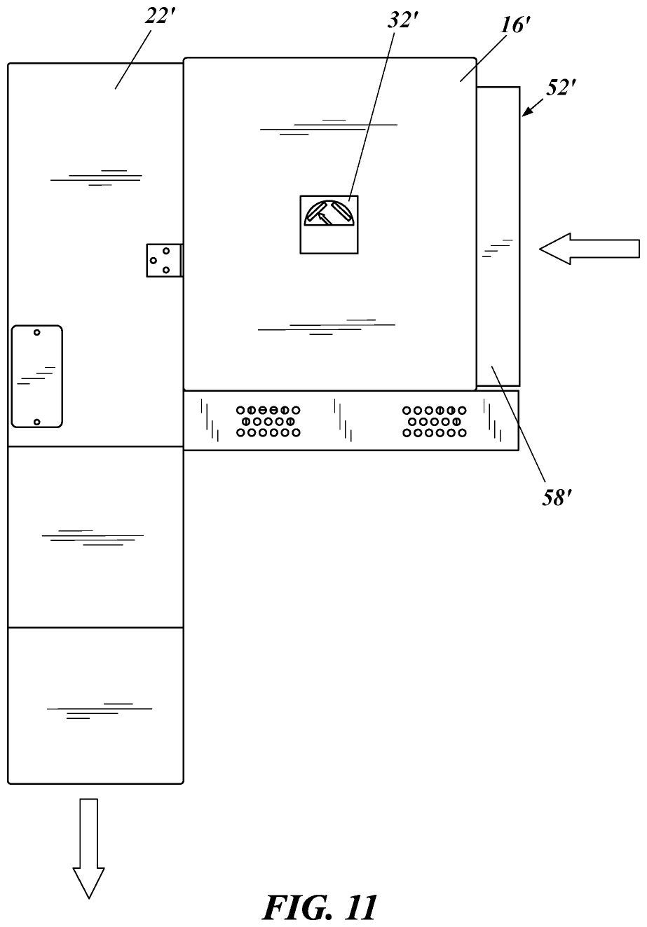

The ventilation system 10 may further include a controller 24 connected to and configured to receive inputs from sensors (such as a cutoff sensor 26) and user controls (such as a physical UV source power switch 28 and blower control 29, or elevator call buttons 30), and to send signals conveying commands and/or information in response to the inputs. These signals may trigger alerts on status displays mounted physically to some part of the ventilation system 10 (such as filter status gauge 32 shown in FIG. 11), or located remotely on a workstation or networked portable device (such as smartphone 34 shown in FIG. 2). For example, the controller 24 may respond to certain sensor readings by sending a signal alerting a user, via a display such as a smartphone 34 or an indicator LED 36 mounted on the illumination chamber 16 or in an elevator machine room, that a UV source 18 has failed, or that a filter 20 has become fouled and requires replacement. The controller 24 may also cause an audible alert to sound, such as an electronic tone or mechanical bell. The controller 24 may even be configured to send certain types of notifications to persons designated to service specific system components.

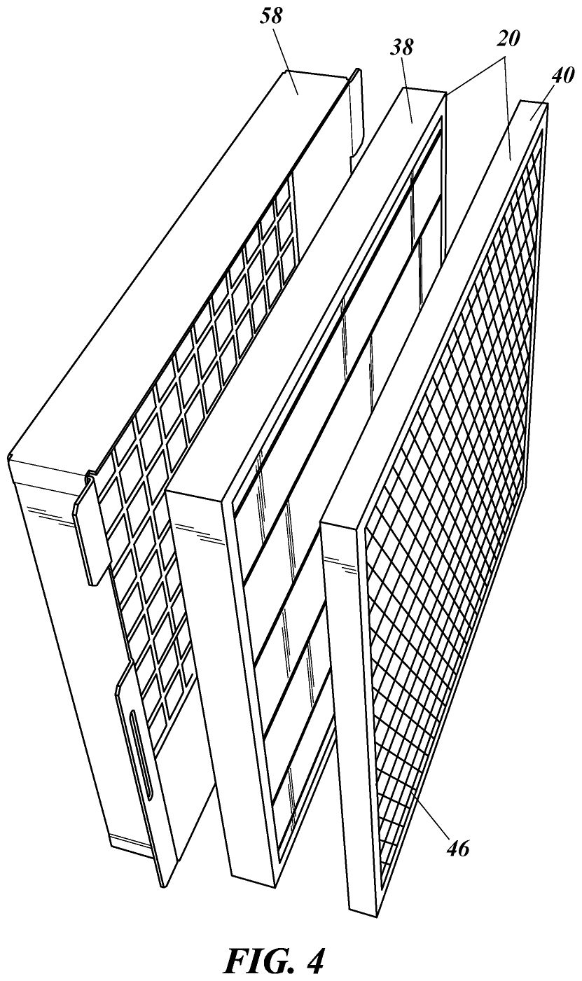

The system 10 may include one or more filters 20 which may comprise various structures and/or media, such as an activated carbon filter 38 shown in FIG. 4, or HEPA and/or ULPA compliant filters 40, as shown in FIG. 4, to capture additional particulates such as mold spores, smoke, bacteria and even particles or liquid droplets that can carry viruses or other pathogens. In embodiments where multiple filters 20 are used, the filters 20 may be installed adjacent one another, as best shown in FIG. 4, or they may be distributed across multiple locations within the system where they will be in communication with air passing through the system, as shown at 20″' in FIG. 23.

To sterilize elevator system air passing through the ventilation system 10, the illumination chamber 16 may carry an array of UV sources 18, and these sources may comprise one or more types of ultraviolet lights or lamps and emitters, such as incandescent, fluorescent, mercury vapor, light-emitting diode, or lasers. These UV sources 18 may be configured to emit any type of light in the sub-400 nm wavelength range, including UV-A, UV-B, and/or UV-C.

The system may also include ion and ozone generators 42, 44, shown in FIG. 2, to augment ion and ozone production from the UV sources 18, or to provide ion and ozone production where non-ionizing or ozone-generating UV bands are used by the UV source 18.

To minimize the risk of harm to elevator passengers or maintenance personnel, the UV sources 18 may be carried by the ventilation system 10 in locations where the UV rays are not directly visible to people occupying and/or servicing the elevator system. These UV rays may be blocked, at least from some angles, by one or more of the filters 20. In embodiments where the air filters 20 are positioned to receive UV rays from the UV source(s) 18, and as shown in FIG. 4, one or more air filters 20 may be coated with, or otherwise treated with, a substance 46 that is photochemically-reactive to ultraviolet light. Such photochemically-reactive substances 46 may include, for example, titanium oxide or copper, which react with UV light to improve the speed and effectiveness of UV sources 18 in killing pathogens.

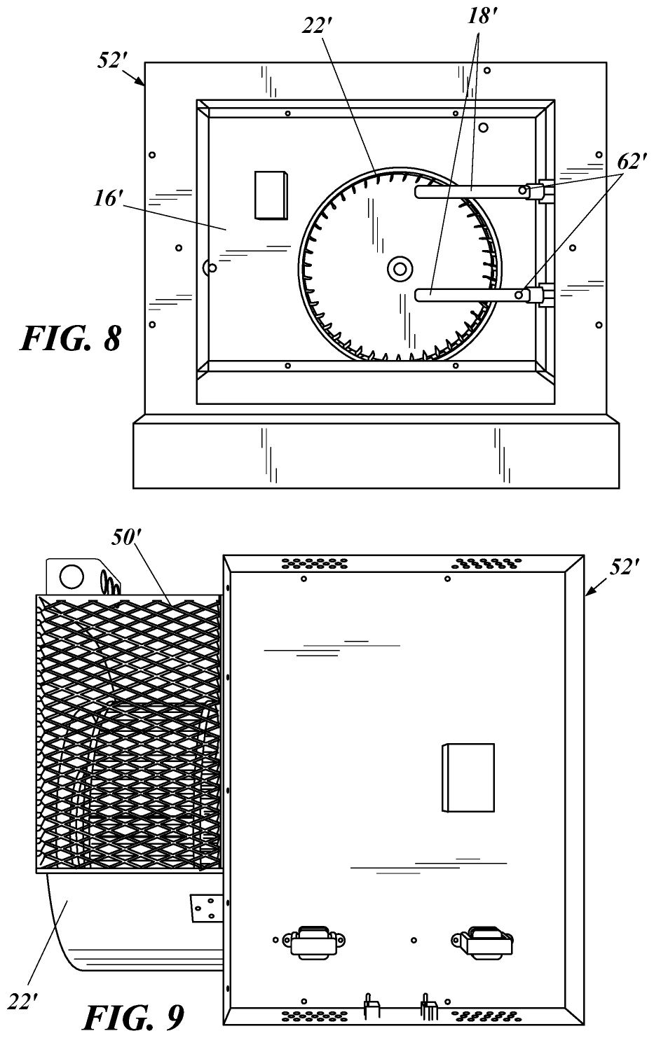

UV rays may also be blocked from other angles by the use of different blower 22 types, for example, the blower 22 may comprise a squirrel cage blower wheel, best shown in FIGS. 2, 8, and 9, which directs the air to efficiently make a roughly 90 degree turn while minimizing static pressure resistance. This squirrel cage blower 22 turn may be used to block the UV sources 18 from the view of elevator occupants or service technicians with more aerodynamic efficiency than blocking the UV rays with a curved duct. However, where other blower 22 types are employed, the UV sources may be hidden from direct outside view by ductwork, by shields 48 carried within the illumination chamber 16, or by one or more filters 20 carried adjacent to the blower 22.

The blower 22 may have single speed, variable speed, or multispeed electrical propulsion. The blower 22 is also not limited to a squirrel cage type, and may alternatively comprise a muffin fan, axial fan, impeller, propeller or any other style of motorized device suitable for moving air. One or more finger guards 50 may be carried by the blower 22 to protect people from possible harm from moving parts of the blower 22, and to protect the blower 22 from debris.

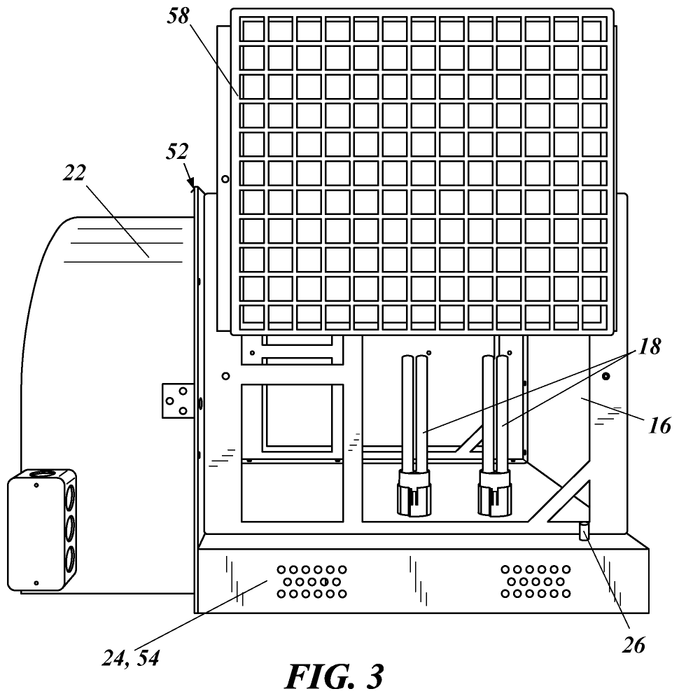

While filters 20, blowers 22, and UV sources of the ventilation system 10 may be distributed at some distance from one another thanks to ductwork, plenums, etc., the air filter(s) 20 and blower(s) 22 may also or alternatively be directly attached to the illumination chamber 16 to comprise a germicidal assembly 52. This germicidal assembly 52 may further include a control module 54 which may carry the controller 24, as well as power control circuitry 56. Electrical connections between the control module 54 and other germicidal assembly 52 components may be readily-detachable connectors such as quick-connect plugs, terminals or other connectors that allow for rapid replacement of the circuitry for minimal elevator system downtime. The germicidal assembly 52 may also carry a blower 22 mounted in a similar readily-separable fashion via readily detachable connectors, and where the blower 22 comprises a squirrel cage blower wheel, the blower 22 may be attached and oriented to block ultraviolet light from the illumination chamber 16 from direct external view of the assembly 52. One or more air filters 20 of one or more types may similarly be carried in a removable filter module 58 shaped to receive filters 20, best shown in FIGS. 3 and 4. The filter module 58 may be positioned so that at least one of its carried filters 20 blocks the UV source 18 from view on at least one side of the germicidal assembly 52. This modularity permits rapid and easy servicing of the germicidal assembly 52.

The germicidal assembly 52 may comprise at least three different embodiments distinguished in the drawings by the absence of a superscript prime mark, the addition of a single superscript prime mark (′), and the addition of a superscript double-prime mark (″) to differentiate one embodiment from another. Similar components of these embodiments are marked by identical numbers in the Figures, and differentiated by superscript prime marks to indicate that these components share function if not precise scale or shape with their similarly-numbered counterparts. For example, a filter is marked 20 if it is shown as part of a first embodiment of germicidal assembly 52, and a filter is marked 20′ where it is part of a second embodiment of the germicidal assembly 52′. Description that applies to one component may be assumed to apply to other components of the same number unless specifically contradicted by disclosure elsewhere.

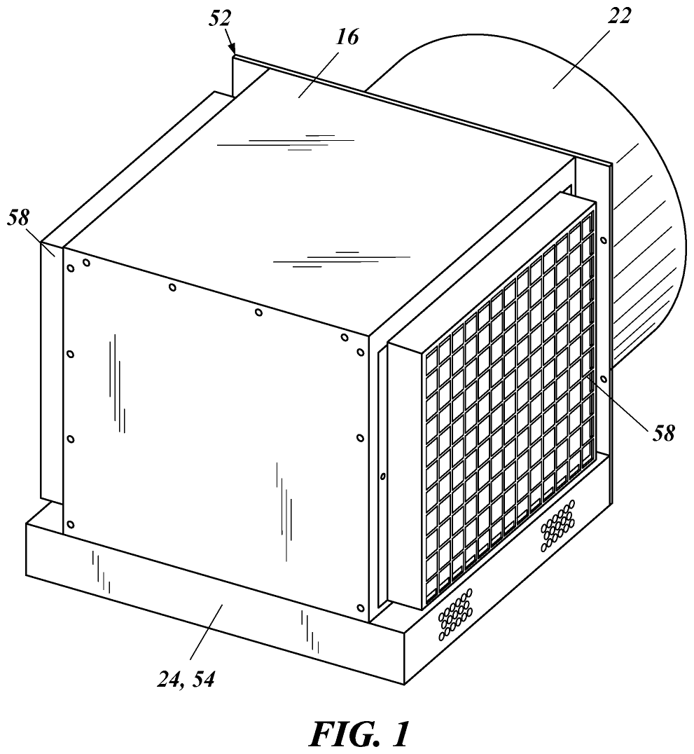

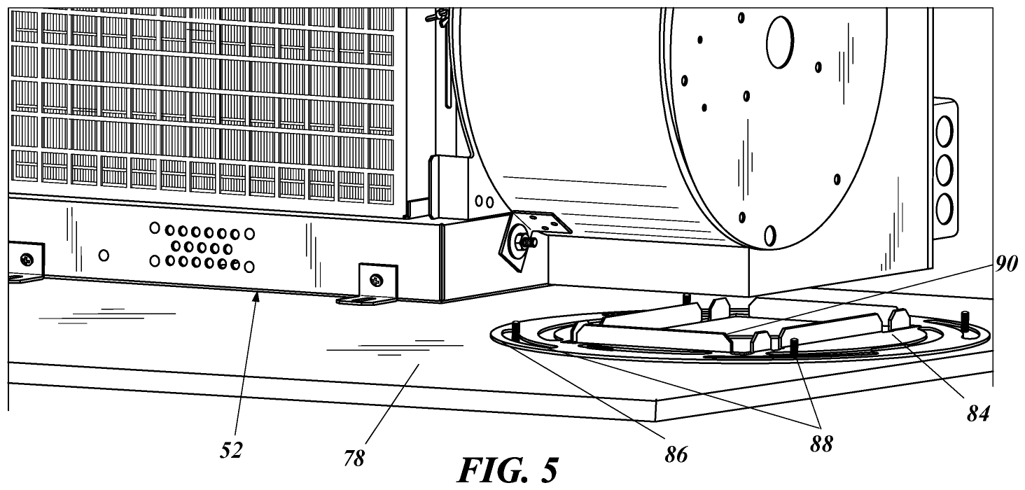

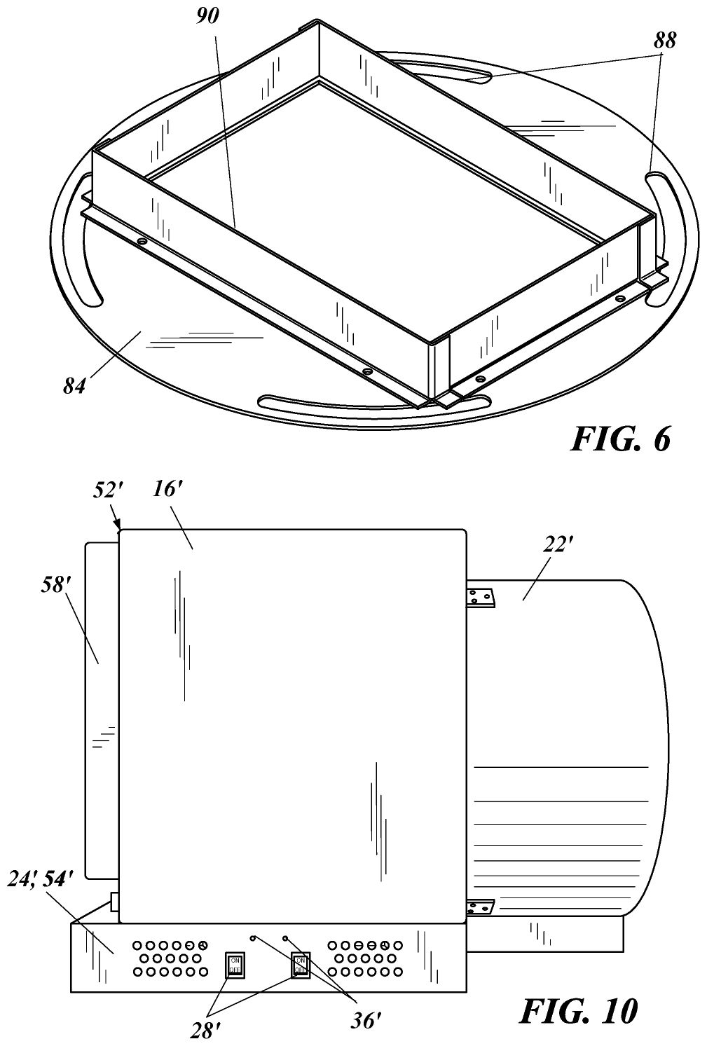

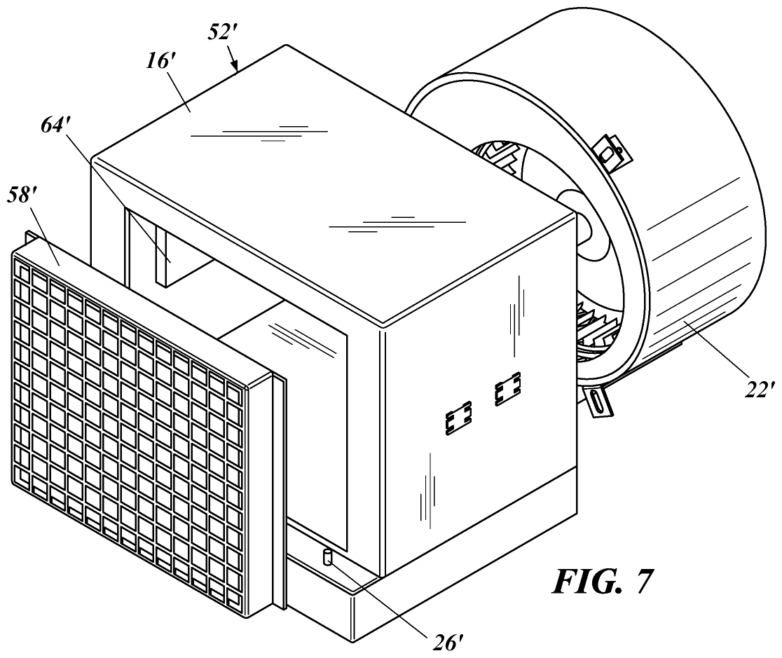

A preferred embodiment of the germicidal assembly, carrying two filter modules 58 on opposing sides is shown at 52 in FIGS. 1-3, 5, 17, and 18. This variant may draw air through twice the filter area as a similar embodiment of the germicidal assembly, shown at 52′ in FIGS. 7-12 and 14, which carries only a single filter module 58, but permits air to take a more direct path to its squirrel cage blower 20.

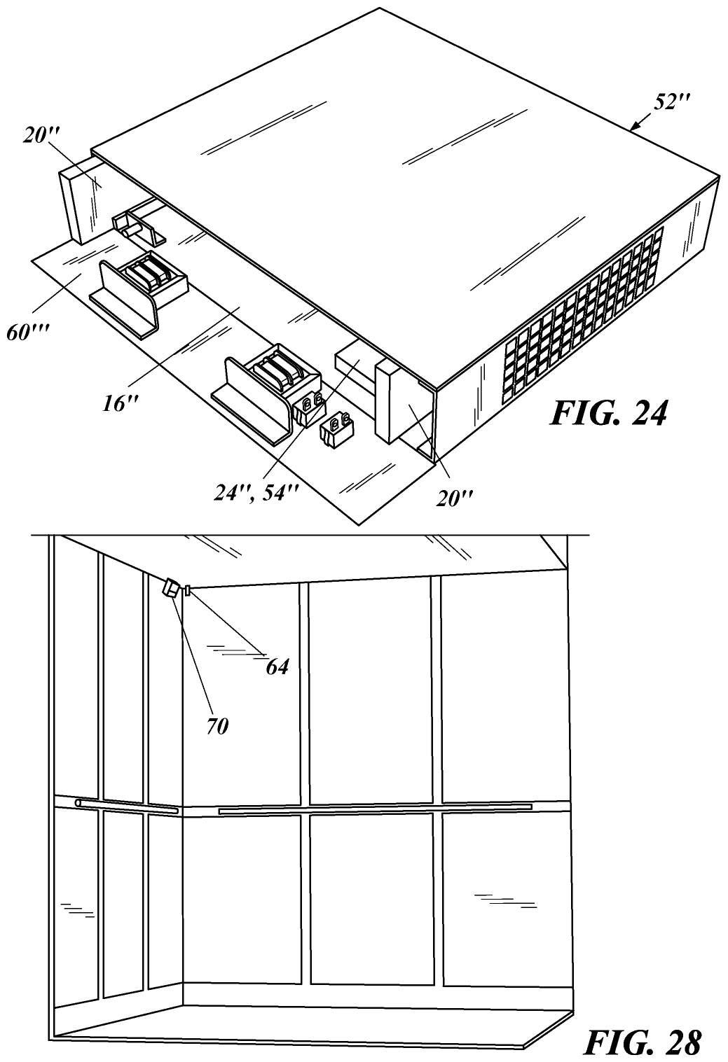

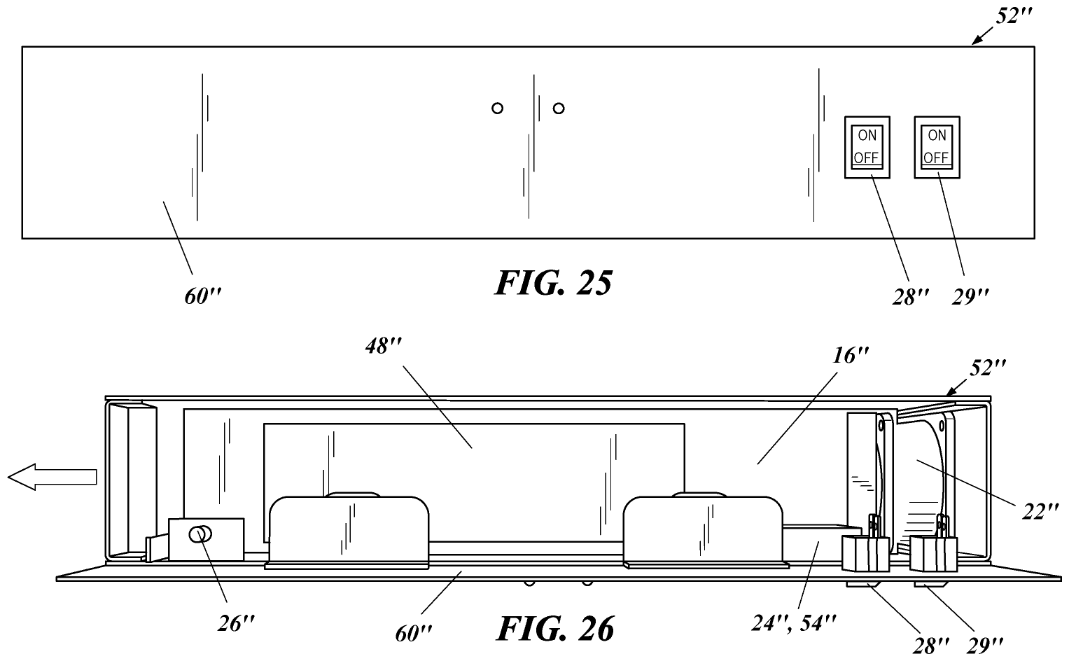

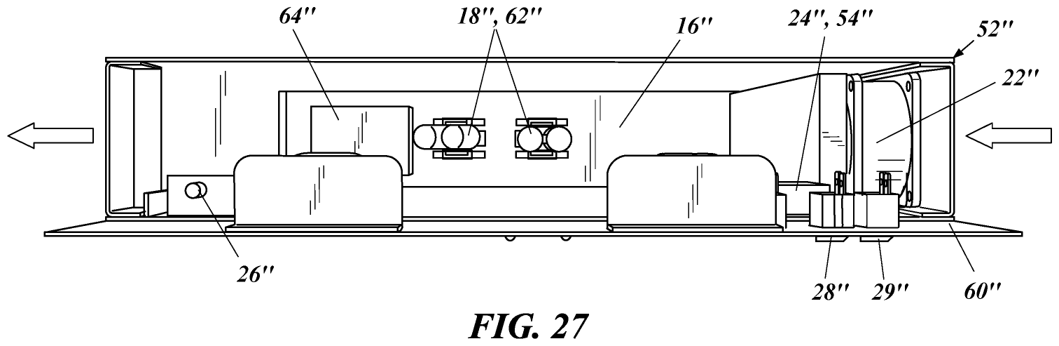

The ventilation system 10 may include one or more cutoff sensors 26 connected to the controller 24 and configured to send a signal to the controller 24 when some portion of the ventilation system 10 is opened or removed (for example, if the filter module 58 is removed to replace a filter 20, exposing the interior of the illumination chamber 16). The controller 24 may be configured to turn off the ultraviolet sources 18 in response to the signal from the cutoff sensor 26. The cutoff sensors 26 may comprise power switches of a plunger design (or any other suitable switch type), and one or more of these cutoff sensor switches 26 may be attached to the germicidal assembly 52 and positioned to sense the removal of components such as filter(s) 20, blower(s) 22, or the opening of access doors 60 (shown in FIG. 24), and/or any other part of the ventilation system 10 which may be removed to access or expose the UV sources 18.

The ventilation system 10 may include an ultraviolet source status sensor, shown at 62 in FIG. 2, connected to the controller 24 and configured to detect whether the ultraviolet source 18 has failed, and to transmit a corresponding signal to the controller 24. This UV source status sensor 62 may comprise any sensor capable of monitoring the UV source 18, such as a circuit that is configured to allow the controller 24 to detect when a UV source 18 has failed or is not drawing as much power. The controller 24 may monitor multiple UV sources 18 individually or as a group via multiple corresponding UV source status sensors 62. Additionally, where multiple UV sources 18 are used, the UV status sensor(s) 62 and controller 24 may be configured to specifically determine and indicate which UV source 18 has failed, for example by activating one of the UV source status indicator lights 36 on the exterior of the germicidal assembly 52, or sending a notification to a remote device 34 networked via a transmitter 35, the failed source 18 may be identified and replaced even if the sources are turned off. This specific identification of the failed UV source 18 is particularly helpful when, for example, the cutoff sensor 26 is triggered by accessing the illumination chamber 16, cutting power to both the working and non-working UV sources 18.

The controller 24 may further be configured to rotate operation of the ultraviolet sources to relieve failed or failing UV sources 18 by activating fresh UV sources 18. Multiple sensor types may be used, and rotation may be determined by one or more criteria. For example, a UV source 18 may be taken out of rotation in favor of a fresh UV source 18 if a UV status sensor 62 detects UV source 18 failure, a drop in UV source 18 output below a given threshold, a drop in the ratio of UV source 18 output to power drawn, or simply the operation of a UV source 18 for a pre-determined amount of time (such as an expected service life). These rotation criteria allow the illumination chamber 16 to be loaded with many fresh UV sources 18, usually operating only one or two of the UV sources 18 at a time, and only requiring servicing when all the UV sources 18 have been used, thus reducing the frequency of maintenance required.

The controller 24 may also be configured to activate additional UV sources 18 at one time to increase total UV output in response to certain conditions. For example, more UV sources may be activated to compensate for an increase in blower speed that would cause air to spend less time passing through the illumination chamber 16. Alternatively, or additionally, the controller 24 may be configured to activate ion and/or ozone generators 42, 44 to improve or augment anti-pathogen effectiveness when blower 20 speed increases.

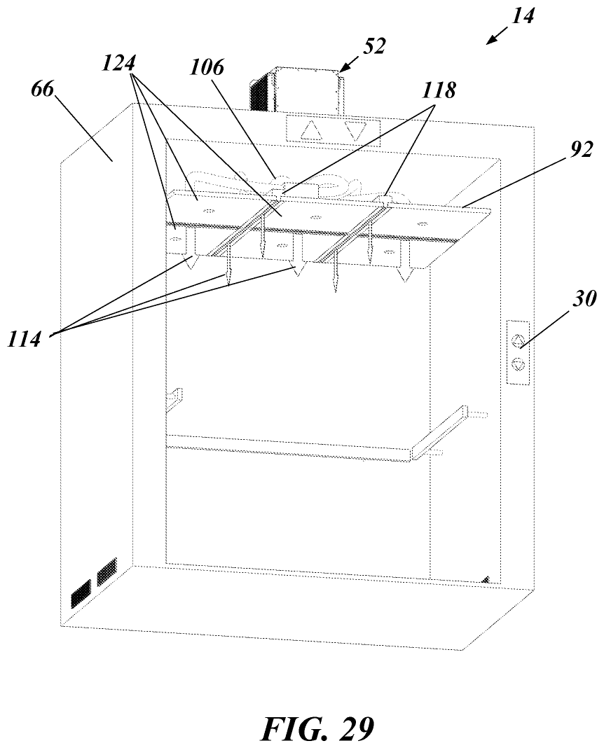

The ventilation system 10 may include one or more types of air sensors 64 connected to the controller 24 and configured to send air data signals to the controller 24. Air sensor 64 types may include air quality or particle sensors (such as the VOC, PM2.5, or PM10 types), air speed sensors, static pressure sensors, etc. These air sensors 64 may be carried by various parts of the elevator ventilation system 10, as shown in FIG. 7, or mounted remotely in positions where they may be needed to determine air data, such as within an elevator car 66, as shown in FIG. 29, in order to determine the quality of the air breathed by passengers.

For example, one of the air sensors 64 may comprise an airflow sensor mounted to the ventilation system 10 in a position (such as immediately downstream of a filter 20 as shown in FIG. 7) where airflow will be affected by fouling of the filter 20, and in response to signals from the air sensor 64 (such as reduced airspeed), the controller 24 may transmit a filter status signal to indicators, such as the filter status gauge 32 mounted on the germicidal assembly 52, as shown in FIG. 11, or a display on remote device 34, indicating the condition of the filter 20, and whether the filter 20 should be replaced. This determination may be made in response to several types of air sensor signals symptomatic of filter condition (changes in sensed airspeed, static pressure, etc.) and may further be combined and compared with other data collected by the controller 24 (such as the blower's selected speed and power draw) for better diagnostic accuracy.

The controller 24 may be further configured to set blower speed in response to a signal received from the air sensor 64. Blower speed may be increased, for example, to compensate for a sensed reduction in airflow due to filter 20 fouling, or in response to unacceptable levels of air quality sensed in the elevator car 66.

The controller 24 may also or alternatively be configured to operate the blower 22 in response to an elevator occupation sensor 70 connected to the controller 24 and configured to detect the presence/absence of passengers within the elevator car 66. For example, the controller 24 may be configured to respond to an absence of elevator passengers by activating the blower 22 at higher speeds that generate higher noise levels and/or wind speeds that might be unpleasant to passengers were they present. The controller 24 may also be configured to change blower speed in response to other signals or criteria, such as a signal from a timer set to expire a predetermined amount of time after the fan began running at high speeds, or an operator input (such as pressing an elevator call button 30). For example, the controller 24 may be configured to idle the blower 20 to save power, then increase blower 20 speed when it determines that an elevator call button 30 has been pressed, and set a timer to reduce fan speed to resume quiet operation speeds once the elevator 66 arrives at the pressed call button 30.

The various components of the elevator ventilation system 10, and embodiments of the germicidal assembly 52, may be located in several different areas of the elevator system, and may be configured to produce several different airflow patterns within the elevator system.

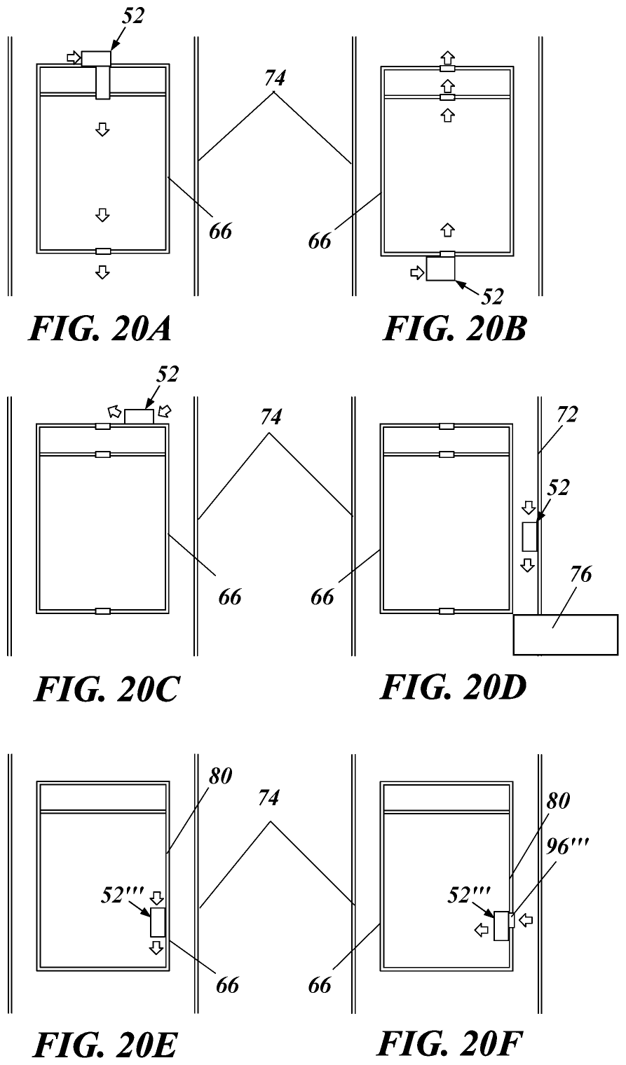

For example, the germicidal assembly 52 may be carried on a wall 72 of an elevator shaft or hoistway 74 and/or landing 76, and configured to recirculate local air, as shown in FIG. 20D. The germicidal assembly 52 may alternatively be carried atop a canopy 78 of the elevator car 66 and configured to recirculate and filter air from the hoistway 74 as shown in FIG. 20C.

Some configurations of the ventilation system 10 may be connected in fluid communication with an interior of the elevator car 66, and in fluid communication with the hoistway 74 via one or more openings in a sidewall 80, canopy 78 and/or in a portion of a sidewall adjacent a floor 82 of the elevator car 66. These embodiments may be configured to impel elevator system air from the hoistway 74 and propel the air into the elevator car 66, providing a positive-pressure environment within the elevator car 66 where the air within the elevator is continuously replaced with filtered air, as shown in FIGS. 20A, 20B, and 20F. Alternatively these configurations may reverse their airflow, impelling elevator system air from the elevator car 66, and propelling the air into the hoistway 74, providing a negative-pressure environment within the elevator car 66, where elevator air is continuously replaced with filtered air from the hoistway 74 (while the air may not necessarily be filtered on its way into the elevator 66 in this case, the hoistway 74 air would have been filtered when it was last expelled from the elevator 66).

The germicidal assembly 52 may be carried atop the canopy 78 or under the floor 82 of the elevator car 66, and mounted, via an adapter plate 84, to an opening 86 cut into the elevator canopy 78 or floor 82 for an existing (old) ventilation system, so that the germicidal assembly 52 is carried in fluid communication with the interior of the elevator car 66. The adapter plate 84 may contain a selection of mounting provisions 88 (such as holes and mechanical fastenings) that match up with the mounting hardware of previously mounted fans. And the adapter plate may include an interface opening 90 shaped to receive the ventilation system 10, while covering the existing opening 86 in the elevator canopy 78 or floor 82.

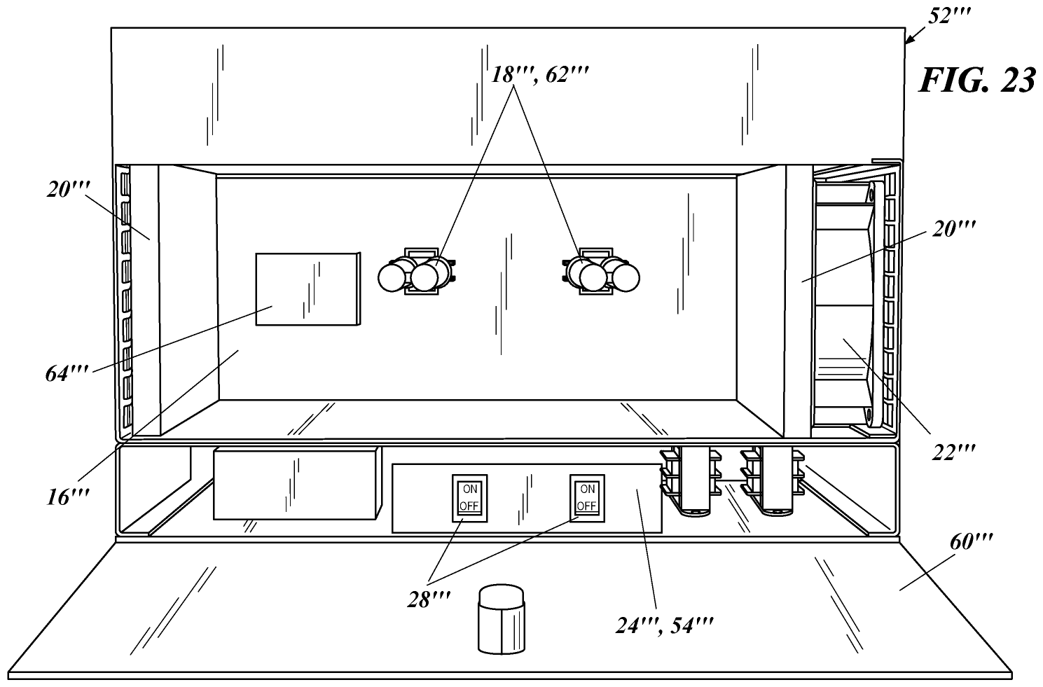

A low-profile embodiment of the germicidal assembly 52″, shown in FIGS. 16 and 20-22, may be shaped to be carried between a drop ceiling 92 and the canopy 78 of the elevator car 66. The low-profile germicidal assembly 52″ may be connected in fluid communication with the hoistway 74 through the canopy 78 of the elevator via a low-profile duct 94″.

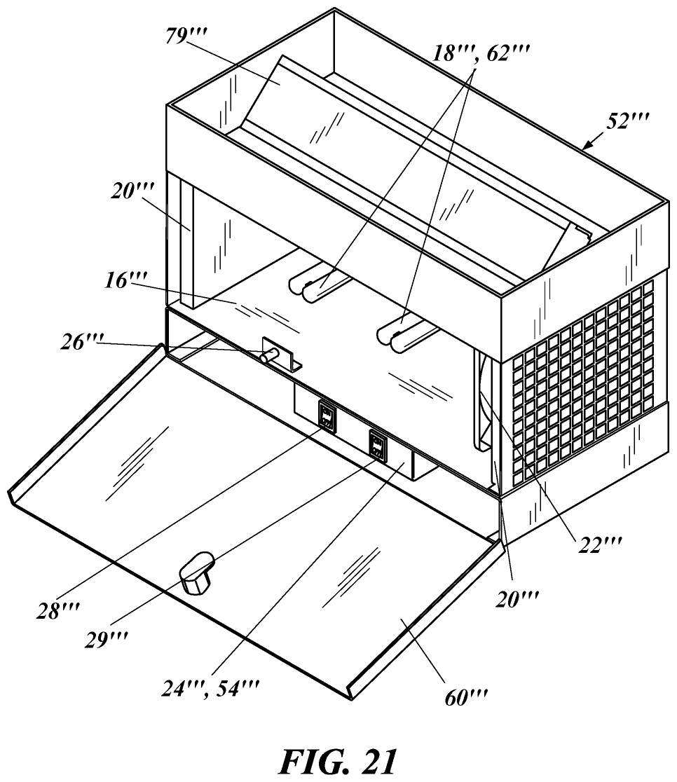

A compact wall-mounted embodiment of the germicidal assembly 52′″ is best shown in FIGS. 21-23. It may carry a light 79 (for example an emergency LED) to illuminate the elevator interior. This compact germicidal assembly 52″′ may be mounted to the wall 80 of the elevator car 66 and configured to filter and recirculate air within the elevator car 66 without direct fluid communication to the hoistway 74, as shown in FIG. 20E. Alternatively, the compact germicidal assembly 52′″ may be connected in fluid communication between the elevator and the hoistway 74 via an opening 96″′ in the elevator wall 80, as shown in FIG. 20F.

These low-profile 52″ and compact 52′″ embodiments of the germicidal assembly may permit generally linear airflow, preferably using one of the blower 22 options that does not have the 90 degree turn of a squirrel cage blower 22. These embodiments may include a filter 20 installed adjacent the blower 22 to block UV light from directly escaping through the blower 22, as best shown in FIGS. 23 and 24.

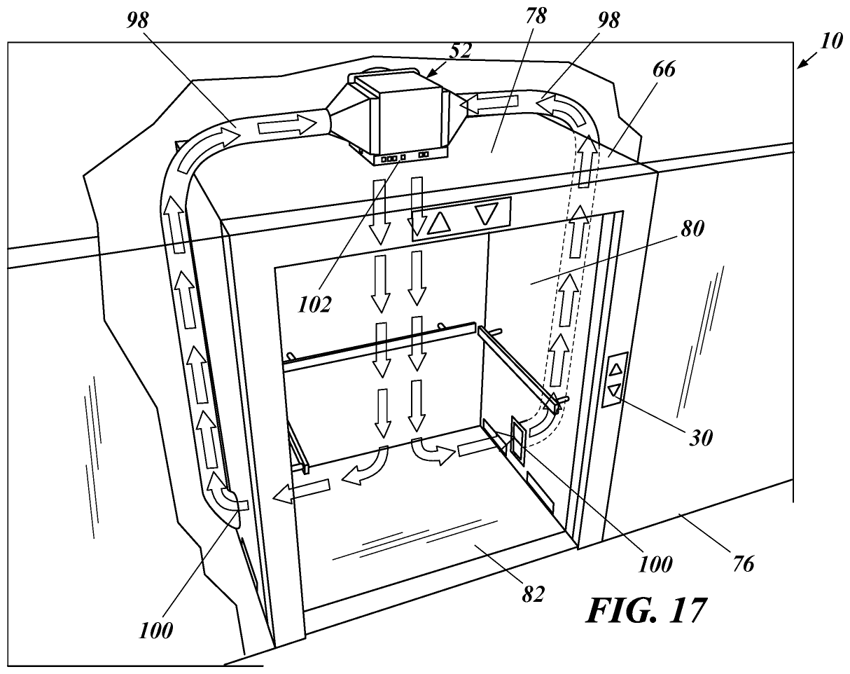

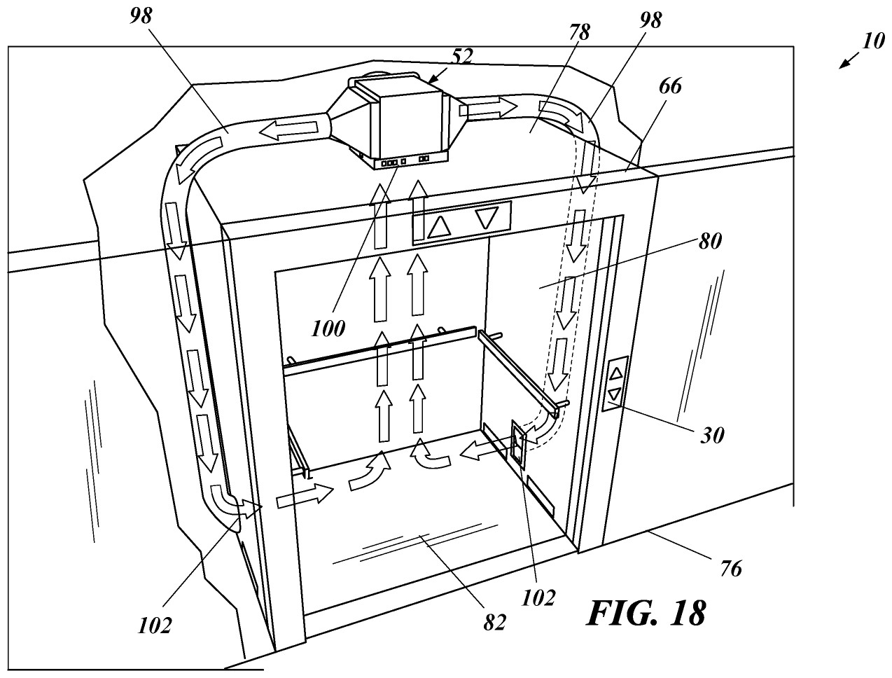

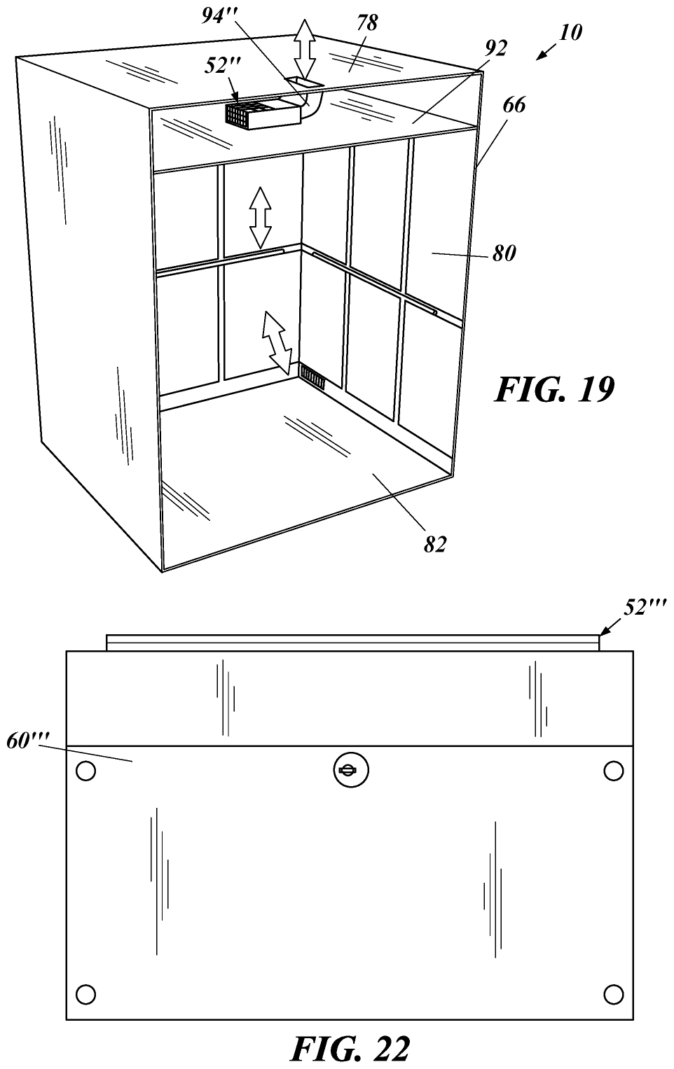

The elevator ventilation system 10 may be configured to move air in a generally vertical direction through elevator car 66, carrying the exhalations of any elevator passenger in a direction either generally upward or downward, and away from the faces of other passengers. This may be accomplished by moving hoistway air into the interior of the elevator car 66 at a location vertically spaced from a location where air inside the car 66 is moved out of the elevator car 66 and back into the hoistway 74, as shown in FIGS. 19, 20A and 20B. Alternatively, generally vertical airflow within the car 66 may be produced by recirculating air within the elevator car 66 interior by equipping the germicidal assembly 52 with recirculation ducts 98 running vertically adjacent at least one wall 80 of the elevator car 66 to allow a blower 20 to intake air from one or more intake vents 100 carried by the elevator car 66 and exhaust air from one or more exhaust vents 102 carried by the elevator car 66 in a location vertically spaced from the intake vent 100, as shown in FIGS. 17 and 18.

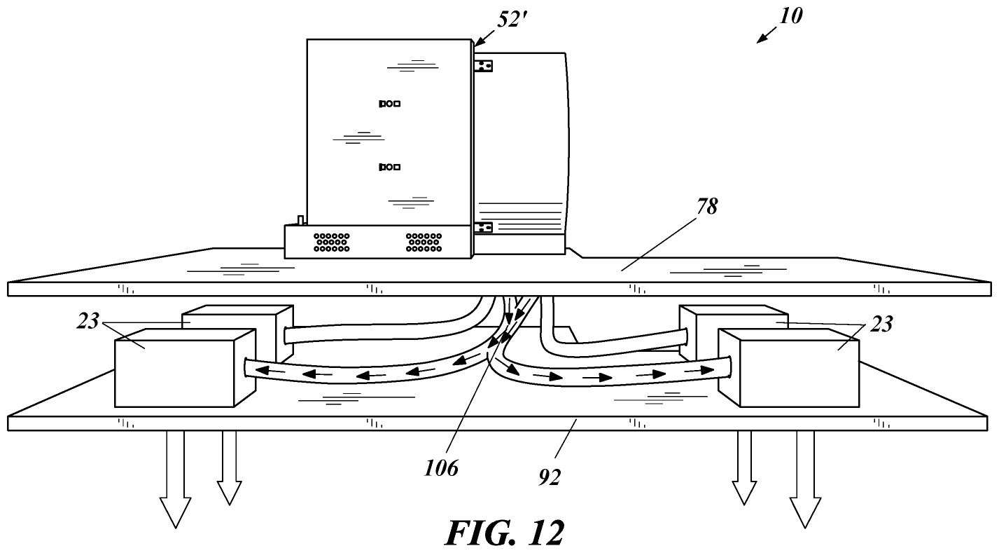

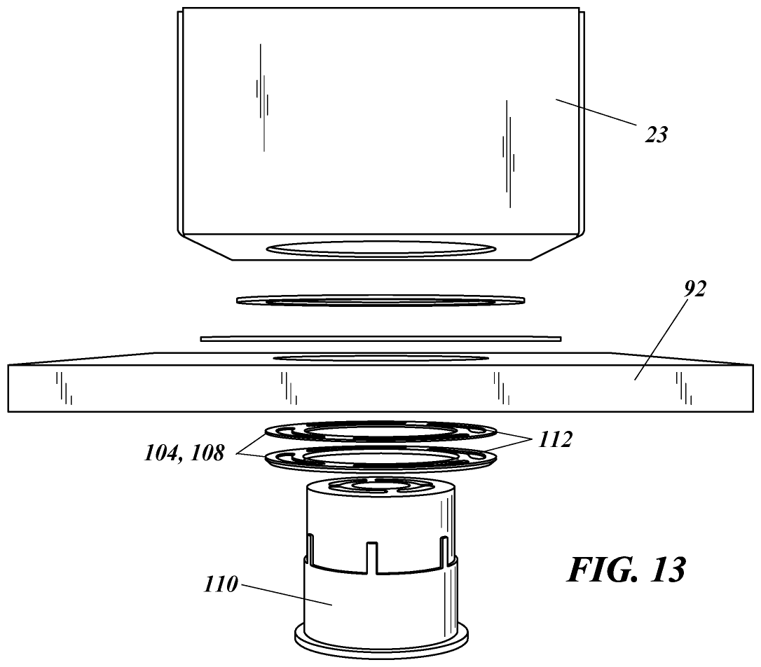

To produce a more evenly-distributed vertical flow of air, an array of air outlets 104 may be located adjacent an upper end of the elevator interior, and connected in fluid communication with at least one blower 22 and with the elevator interior. As shown in FIGS. 12-14, this array of outlets 104 may comprise outlets 104 located in the elevator canopy 78, or in the drop ceiling 92 and configured to direct air through sides or edges of the drop ceiling 92. To provide even air flow, air may be distributed to the outlets 104 via a manifold 106 (such as a plenum, duct/tube array or any other suitable fluid distributor may alternatively be used), and multiple blowers 22 may be positioned adjacent the outlets 104, as shown in FIGS. 12 and 13 to augment, or as substitutes for, an optional blower 22 mounted in a germicidal assembly 52.

As best shown in FIG. 13, the outlets 104 may comprise light fixture trim elements 108 shaped to receive elevator light fixtures 110, and/or located adjacent elevator light fixtures 110. These trim elements 108 may comprise, for example, an oversized trim or border ring configured to allow air to be forced into the elevator interior through generally annular apertures 112 surrounding the light fixtures 110. This would allow a large number of “vents” to be hidden in the ceiling, such that a passenger in the elevator car 66 would be unlikely to notice any unsightly vents.

By providing an even airflow to carry exhaled pathogens away in a downward, or (by reversing the blower(s) 22) upward, direction, the array of outlets 104 may limit transmission of pathogens between elevator passengers by airflow alone. Accordingly, the array of outlets 104 may be used to distribute air filtered and sanitized by the elevator ventilation system 10. Alternatively, the outlets 104 may be used as a disguised elevator lighting ventilation system with air filtration and UV sterilization being optional features.

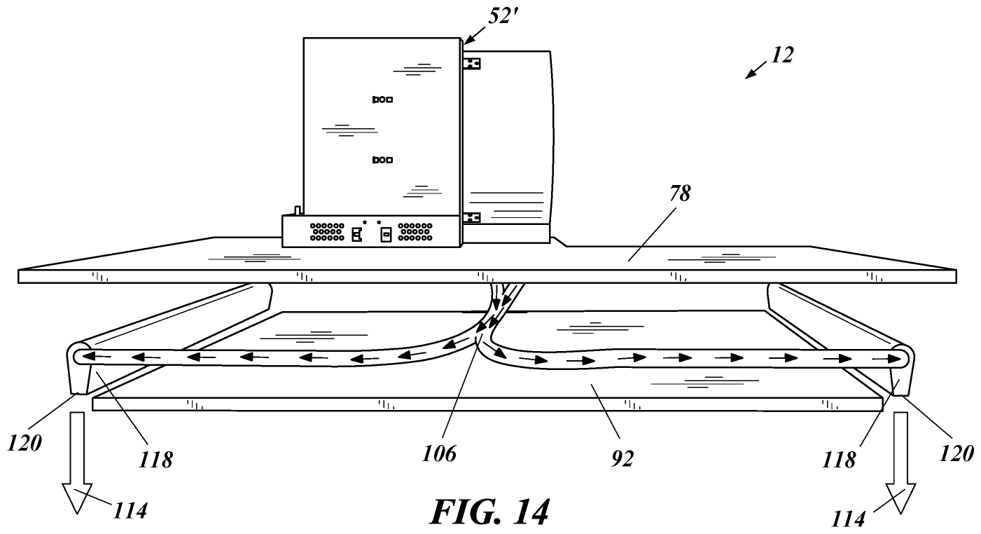

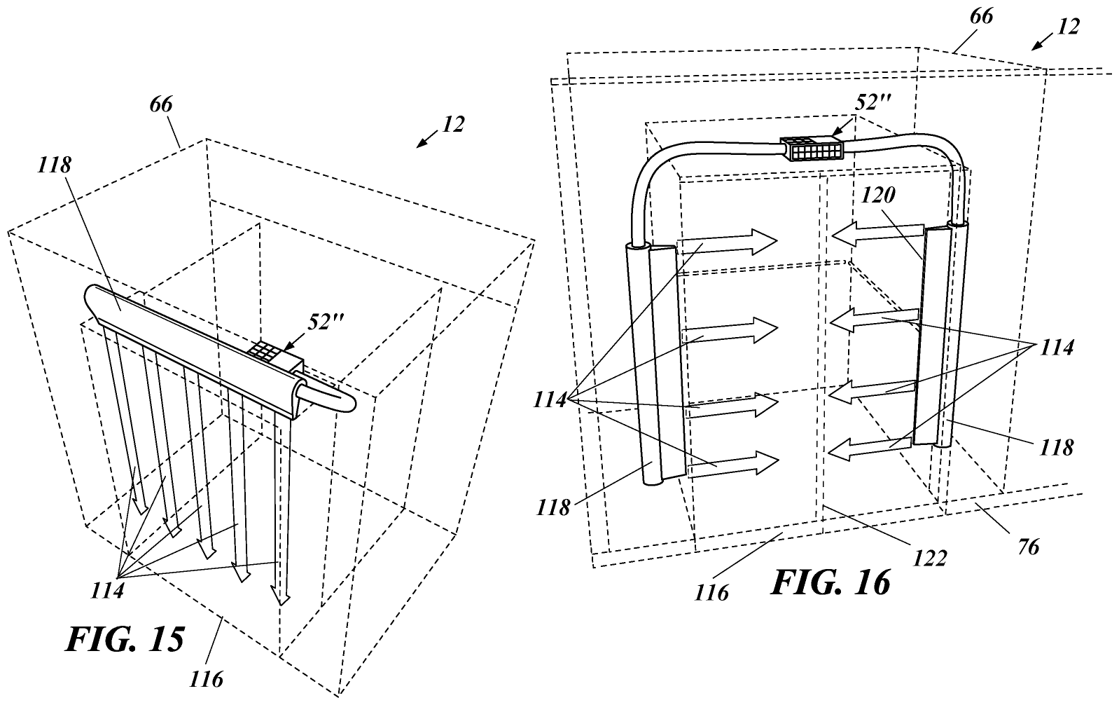

An embodiment of an elevator ventilation system specifically for ventilating an elevator doorway is generally shown at 12 in FIGS. 14-16. The elevator doorway ventilation system 12 may be configured to project one or more air curtains 114 across a doorway 116 of the elevator car 66 and/or landing 76. An air curtain emitter 118 of the doorway ventilation system 12 is positioned adjacent an elevator 66/elevator landing 76 doorway 116, either carried by the elevator 66, as shown in FIGS. 14 and 15, or carried in a fixed position at an elevator landing 76, as shown in FIG. 16.

The air curtain emitter 118 comprises an outlet slot 120 (best shown in FIGS. 14 and 16) connected in fluid communication with a blower 22 (which may optionally be carried in a germicidal assembly 52) and shaped to emit a generally sheet-shaped air curtain. The air curtain emitter 118 may be positioned to emit the air curtain 114 across the elevator 66 or elevator landing 76 doorway 116, in any desired direction (upward, downward, sideways, etc.), so that, when an elevator car 66 arrives at the elevator landing 76 and the elevator doors open, the air curtain 114 forms a generally coherent flow across the open doorway 116, which limits air communication between the interior of the elevator 66 and the building beyond the elevator landing 76.

Multiple air curtain emitters 118 may be mounted to provide air curtains for elevators with multiple doorways 116 (a multiple-doorway-elevator compatible arrangement is shown in FIG. 14). Multiple air curtain emitters 118 may also be used to address a single doorway 116, for example, two of the air curtain emitters 118 may be aimed to blow air curtains 114 across the elevator/landing doorway 116 from opposing sides, as shown in FIG. 16. This arrangement may mitigate the diffusion of air curtains 114 with distance from the curtain emitter 118.

If the elevator doorway ventilation system 12 is installed in a stationary part of a building, such as at each elevator landing 76, rather than in an elevator 66, the weight restrictions that constrain the design of such systems 12 for mounting on elevators may be avoided, permitting the installation of larger and more powerful doorway ventilation systems 12. The air curtain emitters 118 may also be optionally fed air sanitized via the filters 20 and UV sources of a germicidal assembly (the low-profile germicidal assembly 52″ is shown in FIGS. 15 and 16, but a larger germicidal assembly 52′ may also be used as shown in FIG. 14).

The controller 24 may be configured to deploy the air curtain(s) 114 by activating the blower 22 in response to a signal corresponding to the position of the elevator 66 or the elevator doors 122, for example, the controller 24 may deploy the air curtain(s) 114 when it determines that the elevator 66 is approaching a landing 76, or it may keep the air curtain(s) 114 running for as long as the elevator doors 122 are open.

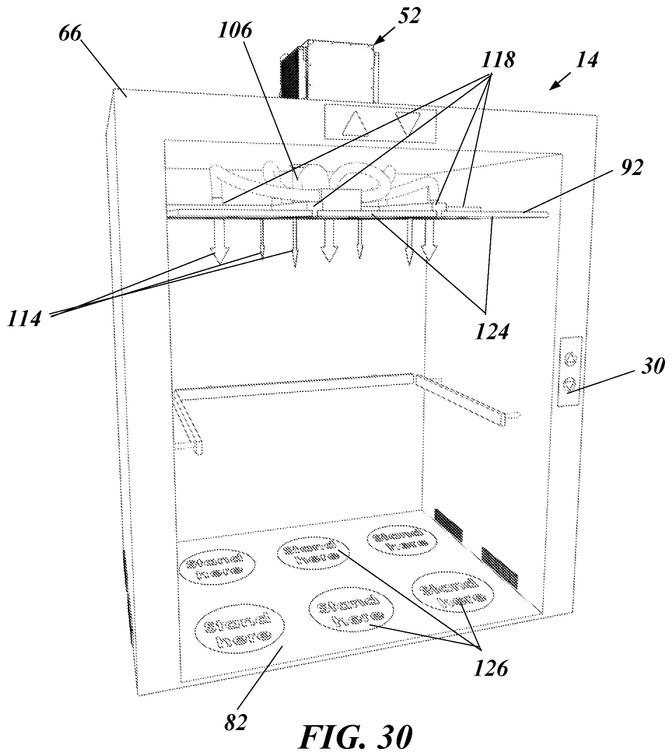

An elevator ventilation system embodiment configured to employ one or more air curtains to compartmentalize an elevator cab interior, is generally shown at 14 in FIGS. 29 and 30. The compartmentalizing air curtain elevator ventilation system 20 may comprise an air curtain emitter 118 supported on the elevator car 66 and connected in fluid communication with the blower 22, the air curtain emitter 118 being shaped and aimed to separate an interior of the elevator car 66 into at multiple air compartments defined by a barrier or barriers formed by its emitted air curtain(s) 114. Alternatively, multiple air curtain emitters 118 may be arranged to divide the elevator interior into the multiple air compartments by emitting multiple air curtains 114 as shown in FIG. 29. These air curtains will impede the transmission or exchange of exhaled pathogens between elevator passengers positioned in respective separate air chambers.

In the preferred embodiment of the compartmentalizing air curtain elevator ventilation system 14 shown in FIGS. 28 and 29, the air curtain emitters may be supplied with air from a blower 22 via a manifold 106 comprising tubes, plenums or any other suitable air distributor(s), and supported by the elevator 66 to project curtains of air 114 between tiles 124 of the drop ceiling 92. The individual air chambers may thus be defined by the size of the drop ceiling tiles 124, although the air curtain emitters 118 may be arranged to create air chambers of any size or shape. As shown in FIG. 30, air chamber indicator markings 126 may be applied to the elevator floor 82 to inform passengers of the location of each air chamber.

This description, rather than describing limitations of an invention, only illustrates an embodiment of the invention recited in the claims. The language of this description is therefore exclusively descriptive and is non-limiting. Obviously, it's possible to modify this invention from what the description teaches. Within the scope of the claims, one may practice the invention other than as described above.

What is claimed is:

1. An elevator ventilation system comprising;
an illumination chamber positioned in fluid communication with elevator system air;
an ultraviolet source positioned to illuminate elevator system air flowing through the illumination chamber;
an air filter positioned to filter elevator system air flowing through the illumination chamber;
a blower disposed in fluid communication with the illumination chamber, and configured to move elevator system air through the illumination chamber and through the air filter; and
the ultraviolet source being blocked from view from positions outside the illumination chamber.

2. The elevator ventilation system of claim 1 in which light from the ultraviolet source is at least partially blocked from view by the air filter, and the air filter comprises a substance that is photochemically-reactive to ultraviolet light.

3. The ventilation system of claim 1, additionally comprising a controller connected to and configured to receive inputs from sensors and user controls, and to send signals conveying commands and/or information in response to the inputs.

4. The elevator ventilation system of claim 3, in which the elevator ventilation system comprises a germicidal assembly in which an air filter and blower are carried by the illumination chamber.

5. The germicidal assembly of claim 4 in which the blower comprises a squirrel cage-type blower wheel carried by the illumination chamber in an orientation where the squirrel cage blower blocks the ultraviolet source from external view.

6. The germicidal assembly of claim 4 additionally comprising a control module removably carried by the germicidal assembly and supporting the controller, electrical connections between the controller and other germicidal assembly components being readily-detachable connectors.

7. The germicidal assembly of claim 4 including a cutoff sensor connected to the controller and configured to send a signal to the controller when some portion of the germicidal assembly is opened or removed, and the controller is configured to turn off the ultraviolet light in response to the signal from the cutoff sensor.

8. The germicidal assembly of claim 7 in which the controller is configured to turn off the blower in response to the signal from the cutoff sensor.

9. The germicidal assembly of claim 7 in which the air filter is carried by the germicidal assembly via a removable filter module shaped to carry a filter, the filter module being positioned so that the filter blocks the ultraviolet source from view on at least one side of the germicidal assembly, and the cutoff sensor being positioned to send a cutoff signal to the controller when the filter module is removed.

10. The ventilation system of claim 3 including an air sensor connected to the controller and configured to send air data signals to the controller.

11. The ventilation system of claim 10 in which the controller is configured to send a filter status signal to a display indicating the condition of a filter in response to a signal from the air sensor that is symptomatic of filter condition.

12. The ventilation system of claim 10 in which the controller is configured to set fan speed in response to a signal received from the air sensor.

13. The ventilation system of claim 3 in which the controller is configured to set fan speed in response to an elevator occupation sensor connected to the controller and configured to detect the presence/absence of passengers within an elevator car of the elevator system.

14. The ventilation system of claim 3 in which the controller is configured to set fan speed in response to signals received from a timer.

15. The ventilation system of claim 3 in which the controller is configured to set fan speed in response to an operator input.

16. The ventilation system of claim 3 including an ultraviolet light status sensor connected to the controller and configured to detect whether the ultraviolet light has failed, and to transmit a corresponding signal to the controller.

17. The ventilation system of claim 16 including more than one of the ultraviolet sources and corresponding ultraviolet source status sensors connected to the controller, the controller being configured to transmit corresponding signals to an indicator, such that the indicator shows which of the ultraviolet sources has failed, even when the ultraviolet lights are turned off.

18. The ventilation system of claim 16 including more than one of the ultraviolet lights, each of the ultraviolet sources being connected to the controller and monitored by a respective ultraviolet source status sensor connected to the controller, the controller being configured to rotate operation of the ultraviolet sources to activate fresh ultraviolet sources in response to receiving signals from the ultraviolet source status sensor.

19. The elevator ventilation system of claim 1 including an ion generator connected in fluid communication with the blower.

20. The elevator ventilation system of claim 1 including an ozone generator connected in fluid communication with the blower.

21. The elevator ventilation system of claim 4 in which the germicidal assembly is connected in fluid communication with an interior of an elevator car of the elevator system, and in fluid communication with a hoistway of the elevator system.

22. The elevator ventilation system of claim 21 in which the elevator ventilation system is positioned to impel elevator system air from the hoistway and propel the air into the elevator car, providing a positive-pressure environment within the elevator car.

23. The elevator ventilation system of claim 21 in which the elevator ventilation system is positioned to impel elevator system air from the elevator car, and propel the air into the hoistway, providing a negative-pressure environment within the elevator car.

24. The elevator ventilation system of claim 21 in which the germicidal assembly is carried on a canopy of the elevator car.

25. The elevator ventilation system of claim 21 in which the germicidal assembly is mounted on a canopy of the elevator car via an adapter plate shaped to attach the germicidal assembly in fluid communication with an interior of the elevator car via an opening cut into the elevator canopy for an existing ventilation system.

26. The elevator ventilation system of claim 21 in which the germicidal assembly is disposed between a drop ceiling and a canopy of the elevator car.

27. The elevator ventilation system of claim 21 in which the germicidal assembly is mounted below the elevator floor.

28. The elevator ventilation system of claim 21 in which the germicidal assembly is mounted to a wall of the elevator car.

29. The elevator ventilation system of claim 4 in which the germicidal assembly is connected in fluid communication with an interior of an elevator car, and configured to recirculate and filter elevator system air within the elevator car.

30. The elevator ventilation system of claim 4 in which the germicidal assembly is connected in fluid communication with a hoistway of the elevator system, and configured to recirculate and filter elevator system air within the hoistway.

31. The elevator ventilation system of claim 1 in which the ventilation system blower is configured to move elevator system air in a generally vertical direction through an interior of an elevator car, carrying the exhalations of any elevator passenger in a direction either generally upward or downward, and away from the faces of other passengers.

32. The elevator ventilation system of claim 1, in which the ventilation system comprises an air outlet array comprising outlets located adjacent an upper end of the elevator interior, and connected in fluid communication with the blower and with the elevator interior.

33. The elevator ventilation system of claim 32, in which the ventilation system comprises multiple blowers distributed amongst and connected adjacent outlets of the outlet array.

34. The outlet array of claim 32 in which the outlets are located in a drop ceiling below a canopy of an elevator car of the elevator system.

35. The outlet array of claim 32 in which the outlets are located adjacent elevator light fixtures.

36. The outlet array of claim 32 in which the outlets comprise light fixture trim elements shaped to receive elevator light fixtures.

37. The elevator ventilation system of claim 4 in which the germicidal assembly is connected in fluid communication with an air curtain emitter aimed to direct a curtain of air across a doorway of an elevator car of the elevator system.

38. An elevator doorway ventilation system comprising;
a blower connected in fluid communication with an air curtain emitter;
the air curtain emitter being positioned adjacent an elevator doorway; and
the air curtain emitter being shaped and aimed to expel a curtain of air, received from the blower, across the elevator doorway, limiting air communication between an elevator interior and the elevator landing when an elevator car arrives at an elevator landing and elevator doors open.

39. The elevator doorway ventilation system of claim 38, in which the air curtain emitter is installed adjacent the elevator landing.

40. The elevator doorway ventilation system of claim 38, in which the air curtain emitter is installed within the elevator car.

41. The elevator doorway ventilation system of claim 38, in which the doorway ventilation system comprises two of the air curtain emitters aimed to blow curtains of air across the elevator doorway from opposing sides.

42. The elevator doorway ventilation system of claim 38 including a controller connected to the blower and configured to operate the blower in response to a signal corresponding to the position of the elevator.

43. The elevator doorway ventilation system of claim 38 including a controller connected to the blower and configured to operate the blower in response to a signal corresponding to the open/shut state of the elevator doors.

44. The elevator doorway ventilation system of claim 38, additionally comprising;
an illumination chamber positioned in fluid communication with the blower and air curtain emitter;
an ultraviolet source positioned to illuminate elevator system air flowing through the illumination chamber;
an air filter carried by the illumination chamber and positioned to filter elevator system air flowing through the illumination chamber;
the blower being configured to move elevator system air through the illumination chamber and through the air filter; and
the ultraviolet source being blocked from view from a position outside the illumination chamber.

45. An elevator light ventilation system comprising;
a blower connected in fluid communication with an air outlet;
the air outlet being shaped to receive an elevator light fixture, and to expel air received from the blower into the elevator interior via an aperture adjacent the light fixture.

46. The elevator light ventilation system of claim 45 additionally comprising;
an illumination chamber positioned in fluid communication with the blower and air curtain emitter;
an ultraviolet source positioned to illuminate elevator system air flowing through the illumination chamber;
an air filter carried by the illumination chamber and positioned to filter elevator system air flowing through the illumination chamber;
the blower being configured to move elevator system air through the illumination chamber and through the air filter; and
the ultraviolet source being blocked from view from a position outside the illumination chamber.

47. An elevator ventilation system comprising;
a blower supported on an elevator car;
an air curtain emitter supported on the elevator car and connected in fluid communication with the blower, the air curtain emitter comprising an air outlet slot shaped to expel a curtain of air;
the air curtain emitter being further shaped and aimed to separate an interior of the elevator car into at least two air compartments defined by the “barrier” of the air curtain.
